(19) United States
(12) Patent Application Publication
(10) Pub. No.: US 2025/0315877 A1
(43) Pub. Date: Oct. 9, 2025

(54) USER-CENTRIC HYPER-PERSONALIZED PRODUCT RECOMMENDATION AND MARKETING SYSTEM AND METHOD

(71) Applicant: HAREX INFOTECH INC., Seoul (KR)

(72) Inventors: Kyung Yang PARK, Seoul (KR); Kyoung Jun LEE, Seoul (KR)

(73) Assignee: HAREX INFOTECH INC., Seoul (KR)

(21) Appl. No.: 18/864,724

(22) PCT Filed: May 2, 2023
(86) PCT No.: PCT/KR2023/005941

§ 371 Date: Nov. 11, 2024

(30) Foreign Application Priority Data
May 11, 2022 (KR) 10-2022-0057680
Nov. 7, 2022 (KR) 10-2022-0146781

(51) Int. Cl. G06Q 30/0601; G06Q 30/0201

(52) U.S. Cl. CPC G06Q 30/0631; G06Q 30/0201

(57) ABSTRACT

A user-centric hyper-personalized product recommendation and target marketing system is provided. The system includes: an input unit that collects user-specific purchase information; a memory that stores a program for generating recommended product information and target marketing information for a target customer on the basis of the user-specific purchase information; and a processor that executes the program stored in the memory, wherein the processor generates a list of user-specific recommended products on the basis of the recommended product information for the target customer, and generates target marketing information by cross-checking the list of user-specific recommended products on a product basis.

### FIELD OF THE INVENTION

The present disclosure relates to a user-centric hyper-personalized product recommendation and marketing system and method.

### BACKGROUND ART

From the perspective of one merchant, target marketing that extracts users who are likely to purchase a certain product has been conducted mainly based on the demographic information of users.

For example, the target marketing has been conducted by a marketing method of recommending products that are likely to be purchased based on age and gender, such as clothing product recommendation for women in their 20s, healthy food recommendation for men in their 40s and 50s, and the like.

However, target marketing methods based on the demographic information of users often lead to incorrect results, such as recommending wrong products. For example, there is a problem of recommending baby diapers to people who do not have children.

Therefore, it is necessary to introduce a target marketing method for merchants based on results of a user-centric hyper-personalized product recommendation system.

### DETAILED DESCRIPTION OF THE INVENTION

### Problem to be Solved

The present disclosure is directed to providing a user-centric hyper-personalized product recommendation and marketing system and method, which reprocesses recommended product information recommended to target customers and generates and provides target marketing information provided to merchants.

However, the objects of the present disclosure are not limited to the above object and other objects may be present.

### Technical Means to Solve the Problem

To achieve the above object, a user-centric hyper-personalized product recommendation and target marketing system of the present disclosure includes an input unit configured to collect user-specific purchase information, a memory configured to store a program for generating recommended product information and target marketing information for a target customer based on the user-specific purchase information, and a processor configured to execute a program stored in the memory, wherein the processor generates a list of user-specific recommended products based on the recommended product information for the target customer and generates target marketing information by cross-checking the list of the user-specific recommended products on a product basis.

In addition, a method performed by a user-centric hyper-personalized product recommendation and target marketing system of the present disclosure includes collecting pieces of purchase information according to completed purchase at a plurality of merchants, generating a list of user-specific recommended products based on recommended product information for a target customer using the purchase information, and generating target marketing information by cross-checking the list of the user-specific recommended products on a product basis.

To achieve the above object, a computer program according to another aspect of the present disclosure is coupled to a computer that is hardware to execute a program for the user-centric hyper-personalized product recommendation and marketing method and stored in a computer readable storage medium.

Other detailed matters of the present disclosure are included in a detailed description and drawings.

### Effect of the Invention

According to the present disclosure, since the target marketing information is generated based on the recommended product information generated by the product recommendation service providing server, it is useful in that there is no need to introduce or develop an additional system for generating target marketing information.

That is, in the case of the related art, the configuration for the product recommendation service for the user and the configuration for the target marketing information providing service for the merchant have been operated by being separately formed, but the present disclosure has the advantage of providing the structure that can be advantageous for both the user and the merchant by eliminating such inefficiency to recommend products that the user may purchase and using the recommended products together as target marketing information.

The effects of the present disclosure are not limited to the above-described effects, and other effects that are not described will be able to be clearly understood by those skilled in the art from the following description.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a user-centric hyper-personalized product recommendation and target marketing system according to one embodiment of the present disclosure;

FIGS. 2A and 2B are views showing one example of a list of recommended products and target marketing information;

FIG. 3 is a view showing one example of actually generating a list of recommended products and target marketing information;

FIG. 4 is a flowchart of a user-centric hyper-personalized product recommendation and target marketing method according to one embodiment of the present disclosure;

FIG. 5 is a view showing a payment model according to the related art and a user-centric payment model according to one embodiment of the present disclosure;

FIG. 6 is a view showing an artificial intelligence model according to the related art and an artificial intelligence model according to one embodiment of the present disclosure;

FIG. 7 is a view showing a product recommendation service providing server using purchase item information according to one embodiment of the present disclosure;

FIG. 8 is a view showing a single merchant and users according to the related art;

FIG. 9 is a view showing a multi-merchant and users according to one embodiment of the present disclosure;

FIG. 10 is a view showing a user-centric artificial intelligence structure according to one embodiment of the present disclosure;

FIG. 11 is a view showing a product recommendation service scenario based on the user-centric artificial intelligence structure according to one embodiment of the present disclosure;

FIG. 12 is a view showing a recommendation service provision using payment data (purchase information) according to one embodiment of the present disclosure;

FIGS. 13 and 14 are views showing performance comparison results of recommendation algorithms according to one embodiment of the present disclosure;

FIG. 15 is a view showing performance results of a matrix-based ECF (M-ECF) according to one embodiment of the present disclosure;

FIG. 16 is a view showing performance results of a vector-based ECF (V-ECF) according to one embodiment of the present disclosure;

FIG. 17 is a view showing preprocessing completion data according to one embodiment of the present disclosure;

FIG. 18 is a view showing product-to-vector (Product2vec) and user propensity vector generation according to one embodiment of the present disclosure;

FIG. 19 is a view showing product recommendation results according to one embodiment of the present disclosure;

FIG. 20 is a view showing a recommendation evaluation scenario according to one embodiment of the present disclosure; and

FIG. 21 is a view showing a product recommendation service providing method using purchase item information according to one embodiment of the present disclosure.

### DETAILED DESCRIPTION OF EXEMPLARY EMBODIMENTS

Advantages and features of the present disclosure and methods for achieving them will become clear with reference to embodiments described below in detail together with the accompanying drawings. However, the present disclosure is not limited to the embodiments disclosed below but may be implemented in various different forms, these embodiments are merely provided to make the disclosure of the present disclosure complete and fully inform those skilled in the art to which the present disclosure pertains of the scope of the present disclosure, and the present disclosure is only defined by the scope of the appended claims.

Terms used in the specification are for describing the embodiments and are not intended to limit the present disclosure. In the present specification, the singular form also includes the plural form unless specifically stated in the phrase. As used herein, “comprises” and/or “comprising” do not preclude the presence or addition of one or more other components other than the stated component. The same reference numerals denote the same components throughout the specification, and the term “and/or” includes each of the stated components and one or more combinations thereof. Although terms such as “first” and “second” are used to describe various components, it goes without saying that the components are not limited by these terms. The terms are only used to distinguish one component from another. Therefore, it goes without saying that a first component described below may be a second component within the technical spirit of the present disclosure.

Unless otherwise defined, all terms (including technical and scientific terms) used in the present specification may be used as meaning commonly understood by those skilled in the art to which the present disclosure pertains. In addition, terms defined in commonly used dictionaries are not construed ideally or excessively unless clearly and specially defined.

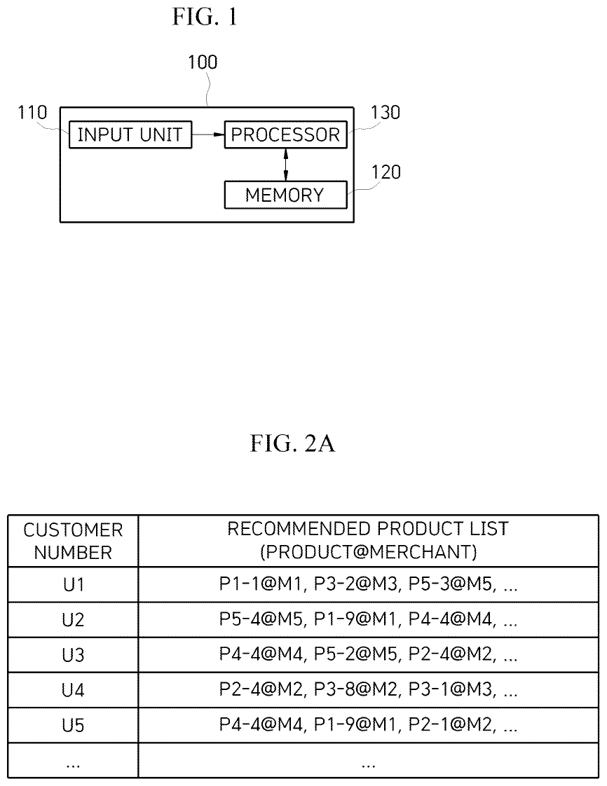

Hereinafter, a user-centric hyper-personalized product recommendation and target marketing system 100 (hereinafter referred to as a system) and method according to one embodiment of the present disclosure will be described with reference to FIGS. 1 to 4. In addition, an embodiment of a product recommendation service providing server 200 and method applicable to FIGS. 1 to 4 will be described with reference to FIGS. 5 to 21. Meanwhile, a product recommendation service applicable to the system 100 and method according to one embodiment of the present disclosure is not necessarily limited to a server 200 and method described in drawings after FIG. 5, and it goes without saying that any applicable product recommendation method may be applied.

FIG. 1 is a block diagram of the user-centric hyper-personalized product recommendation and target marketing system 100 according to one embodiment of the present disclosure.

The system according to one embodiment of the present disclosure includes an input unit 110, a memory 120, and a processor 130.

The input unit 110 collects user-specific purchase information. Here, the user-specific purchase information includes information about a purchase product, a purchase store, a purchase time, and a purchase location.

The memory 120 stores a program for generating recommended product information for target customers and target marketing information for merchant marketing based on the user-specific purchase information.

The processor 130 generates a list of a user-specific recommended products based on the recommended product information for target customers by executing the program stored in memory 120. Here, the recommended product information may be generated by the product recommendation service providing server 200, and detailed description of the product recommendation service providing server 200 will be described below.

In addition, the processor 130 generates target marketing information by cross-checking the list of the user-specific recommended products on a product basis.

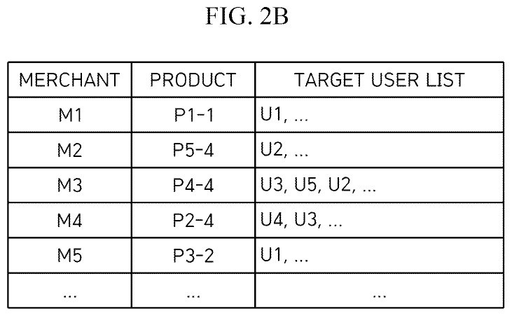

FIGS. 2A and 2B are views showing one example of a list of recommended products and target marketing information.

According to one embodiment of the present disclosure, after a list of recommended products that customers are likely to purchase through the product recommendation service providing server 200, target marketing information may be generated by cross-checking the list on a product basis.

In one embodiment, the number of lists of target marketing information may be determined based on sales volumes of merchants or sales volumes of products.

In another embodiment, regarding target marketing information, the processor 130 may calculate average sales volume information of each merchant for a predetermined period based on a specific product and average sales volume information of all stores, and when a first minimum target marketing information generation condition based on the average sales volume information of all stores is set, the processor 130 may provide target marketing information to merchants that satisfy the first minimum target marketing information generation condition or higher. That is, in the case of merchants with too low sales volumes of a specific product, even when target marketing information is provided, there is a high possibility that the corresponding information may be inaccurate due to a small amount of raw data, and thus according to one embodiment of the present disclosure, the first minimum target marketing information generation condition may be additionally set to ensure the quality of the target marketing information provided to each merchant.

In still another embodiment, regarding target marketing information, the processor 130 may calculate average sales volume information of individual products for a predetermined period of all merchants, and when a second minimum target marketing information generation condition based on the average sales volume information of all products of all merchants for the predetermined period is set, the processor 130 may provide products that satisfy the second minimum target marketing information generation condition as target marketing information. That is, in the case of merchants with too low sales volumes of a specific product among the entire product group, even when the above products are recommended to a specific user, there is a high possibility that target marketing information biased to the specific user is generated, and thus according to one embodiment of the present disclosure, the second minimum target marketing information generation condition may be additionally set to ensure the quality of the target marketing information provided to each merchant.

In the above-described embodiments, it goes without saying that the first minimum target marketing information generation condition and the second minimum target marketing information generation condition may be applied separately or applied simultaneously.

FIG. 2A is an example of a list of recommended products derived by user, in which product P1-1 (MI store), product P3-2 (M3 store), product P5-3 (M5 store), and the like are recommended to user U1 with customer number and product P5-4 (M5 store), product P1-9 (MI store), and product P4-4 (M4 store), and the like are recommended to user U2.

In this case, in one embodiment of the present disclosure, the processor 130 may cross-check a first recommended product information corresponding to a first user included in the list of the user-specific recommended products and generate target marketing information including a plurality of second users including the first user based on the first recommended product information.

FIG. 2B is an example of target marketing information for a merchant, which is generated by cross-checking the list of the recommended products shown in FIG. 2A on a product basis. As a result, target marketing information is generated to target user U1 and the like for product P1-1, and target marketing information is generated to target user U2 and the like for product P5-4.

In addition, the processor 130 may generate target marketing information by arranging a first merchant selling products of the first recommended product information based on purchase information and a second merchant different from the first merchant selling products of the first recommended product information.

That is, in one embodiment of the present disclosure, target marketing information may be generated to target a plurality of users based on the first merchant selling the products of the first recommended product information included in the list of the recommended products and the products. Furthermore, when the first recommended product information and the second merchant are not matched and recommended in the list of the recommended products (or information about the second merchant is not included in the list of the recommended products) but the second merchant also sells the same product, the same type of product, or products in the same category as the first recommended product information, target marketing information may be generated so that the second merchant may target a plurality of users based on the corresponding product just like the first merchant.

In this case, when the first merchant and the second merchant are merchants that sell the same product, such as chain merchants, target marketing information may be generated and recommended to the second merchant as well as the first merchant. As another example, target marketing information may be generated so that the second merchant includes only a user positioned within a preset distance radius among user information included in the targeting marketing information of the first merchant. In addition, the second merchant may receive target marketing information at the request of a merchant owner who operates the second merchant.

In this way, one embodiment of the present disclosure has advantages that product recommendations can be provided to users who are target customers and target marketing information can be provided to merchants.

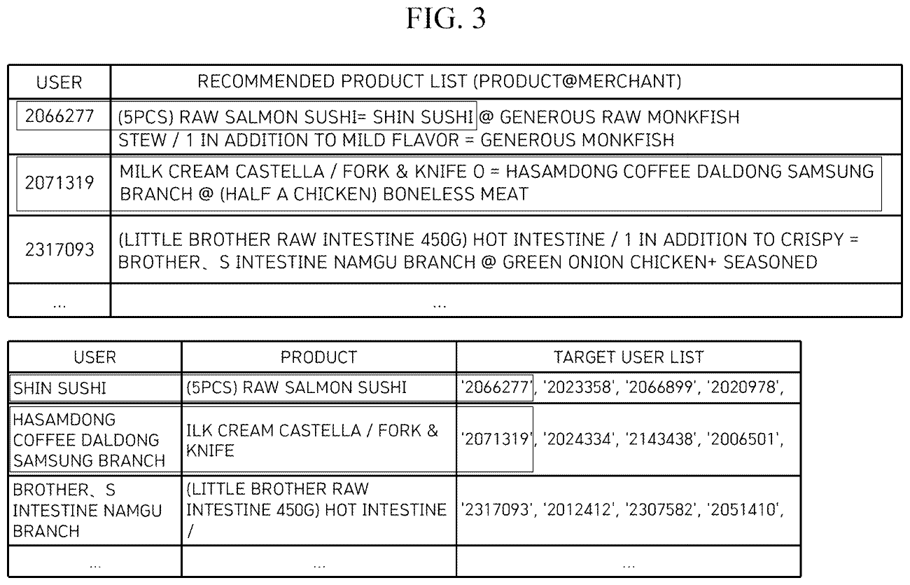

FIG. 3 is a view showing one example of actually generating a list of recommended products and target marketing information.

A test for one embodiment of the present disclosure was performed based on data from Ulsan Pedal, which provides delivery and ordering services in an Ulsan region. For example, when a list of recommended products was checked through a product recommendation service providing server, it can be confirmed that “raw salmon sushi” sold at “Shin Sushi” was recommended to user “2066277,” and “milk cream castella” sold at “Hasamdong Coffee Daldong Samsung Branch” was recommended to user “2071319.” According to the processor according to the present disclosure, target marketing information may be generated by cross-checking a list of recommended products on a product basis, and in the generated target marketing information, marketing may be performed so that a customer, such as “2066277,” who is likely to purchase “raw salmon sushi” at “Shin Sushi” may be recommended as a target, and marketing may be performed so that a customer, such as “2071319,” who is likely to purchase “milk cream castella” at “Hasamdong Coffee Daldong Samsung Branch” may be recommended as a target.

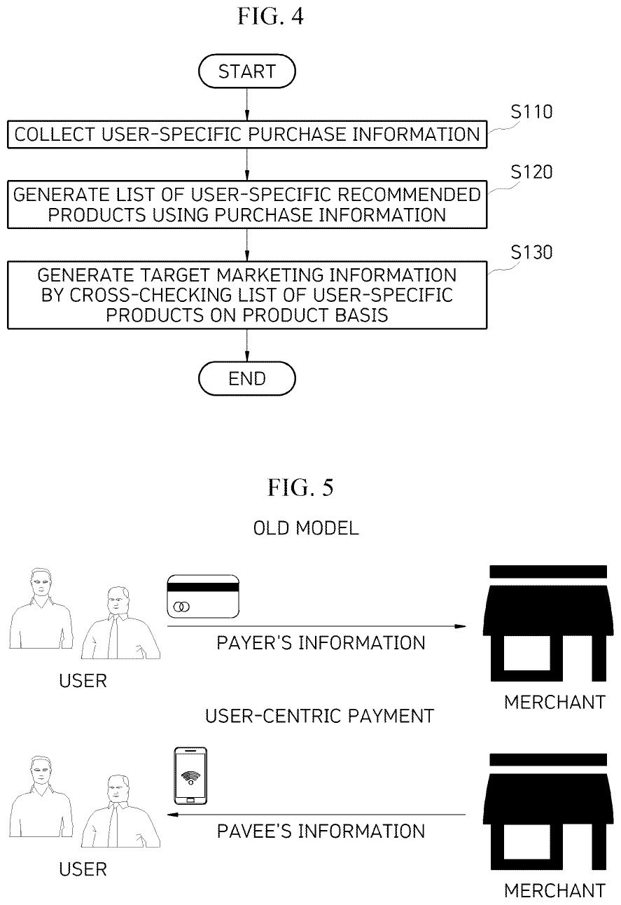

FIG. 4 is a flowchart of a user-centric hyper-personalized product recommendation and target marketing method according to one embodiment of the present disclosure. Meanwhile, it can be understood that operations shown in FIG. 4 are performed by the system 100 described in FIGS. 1 to 3, but the present disclosure is not necessarily limited thereto.

First, the system 100 collects purchase information according to completed purchases at a plurality of merchants (S110).

Next, the system 100 generates a list of user-specific recommended products based on recommended product information for target customers using the purchase information (S120).

Next, the system 100 generates target marketing information by cross-checking the list of the user-specific recommended products on a product basis (S130).

Meanwhile, in the above description, the operations S110 to S130 may be subdivided into a larger number of operations or combined into a smaller number of operations according to embodiments of the present disclosure. In addition, some operations may be omitted as needed, or the order between the operations may be changed. Meanwhile, even when other omitted contents are present, the contents of FIGS. 1 to 3 are also applied to the user-centric hyper-personalized product recommendation and target marketing method of FIG. 4.

According to the above-described one embodiment of the present disclosure, since the target marketing information is generated based on the recommended product information generated by the product recommendation service providing server 200, it is useful in that there is no need to introduce or develop an additional system for generating target marketing information. That is, in the case of the related art, the configuration for the product recommendation service for the user and the configuration for the target marketing information providing service for the merchant have been operated by being separately formed, but the present disclosure has the advantage of providing the structure that can be advantageous for both the user and the merchant by eliminating such inefficiency to recommend products that the user may purchase and using the recommended products together as target marketing information.

Hereinafter, the product recommendation service providing server 200 and method for the user-centric hyper-personalized product recommendation and target marketing system 100 and method according to one embodiment of the present disclosure will be described in detail with reference to FIGS. 5 to 21.

Meanwhile, in one embodiment of the present disclosure, the user-centric hyper-personalized product recommendation and target marketing system 100 described in FIG. 1 and the product recommendation service providing server 200 described in FIG. 7 are described as being configured as the independent system 100 or server 200, respectively, but are not limited thereto. That is, it goes without saying that the system 100 and the server 200 may be the same object or implement in any form according to an operator, such as being operated in a form in which an independent program is installed on a single server system.

Hereinafter, for better understanding of those skilled in the art, the background of the proposed present disclosure will be described first, and then one embodiment of the present disclosure will be described.

In order for an artificial intelligence (AI) system to exhibit good performance, training through a large amount of data is essentially required.

Many companies providing AI services transfer important personal information, such as voice data and text data, to a cloud server to collect a large amount of data, and the data transferred in this way is used to improve the performance of AI models.

For example, in the case of an AI speaker service developed by a domestic company, the task of recording users' conversations and converting the conversations into text is being carried out for the purpose of improving the performance of the AI service.

This is done using the user's voice data to increase a voice recognition rate, and since the task of converting recorded contents into text is handled by a subsidiary, there is a problem that a third-party employee listens to the user's voice data, which poses a serious threat to personal privacy, and similarly, there is a concern about personal information infringement in an AI secretary service.

This is also the case when a product recommendation service is provided to customers using an AI system. That is, when products are recommended using customers' personal information (gender, age, occupation, and the like), there is a problem that personal privacy cannot be preserved in the process of obtaining the customers' user information.

In addition, when a payment service provider wants to recommend products based on customers' payment histories, each merchant defines different product code information, and thus there is a problem of low realism because the code information between merchants needs to be integrated to recommend appropriate products, and furthermore, when a payment service is provided in a global market, there is a problem that it is difficult to provide an appropriate recommendation service in response to environmental factors such as unique products in each country.

Various studies are being conducted to resolve the trade-off relationship between the acquisition of user data and the preservation of personal privacy, and in one embodiment of the present disclosure, an AI service that can achieve intended results while preserving the privacy of personal users and at the same time, enabling the cooperation that maximizes the preservation of information of corporate (organizational) users is defined as a user-centric AI service.

As a specific example of the user-centric AI service according to one embodiment of the present disclosure, there are proposed the server 200 and method, which may provide an appropriate product recommendation service to target customers using purchase information of other customers with high purchase similarity with the target customer without using the customers' personal information.

According to one embodiment of the present disclosure, only the purchase information is used without using the users' personal information, and from the perspective of a single merchant, to supplement insufficient data situations, a product recommendation service is provided using an extrapolative collaborative filtering (ECF) that reflects pieces of purchase information of other merchants and provides recommendations.

Hereinafter, according to the above-described result of the verification, it can be confirmed that appropriate product recommendations are possible without exposing information about personal privacy and information about each merchant using only purchase information maintained for performing the payment service without using personal information.

In addition, as the result of performing verification using the data of the payment service provider according to one embodiment of the present disclosure, it can be confirmed that appropriate recommendations are possible even when purchase information is used in natural language without categorizing product names.

FIG. 5 is a view showing a payment model according to the related art and a user-centric payment model according to one embodiment of the present disclosure.

A payment model in the user-centric AI service according to one embodiment of the present disclosure has main features that a user-centric payment sharing platform-based service is provided and financial information of a paying individual is not transferred to a merchant.

That is, since an ID of a merchant is transferred to a user system of the merchant and a payment service is processed in the user's system (e.g., a smartphone) rather than a structure in which the user's financial information is transferred to the merchant and a system of the merchant is connected to a financial agency as in the related art, the payment may be made without the intervention of an intermediary between the paying user and the financial agency, and thus the user's personal information is not unnecessarily transferred to business operators, but rather pieces of information of the business operators are accumulated in the user's system, thereby creating the foundation of the user-centric service.

According to the payment model in such a user-centric AI service without the intervention of the intermediary, a fee of a VAN company and a fee of a PG company of the business operators can be reduced, and the risk of leakage of personal information of the customers can be reduced.

In addition, the burden of fees of the business operators can be reduced, and the customers' convenience can be increased as a composite payment capable of processing payment, membership, and the like at once is possible.

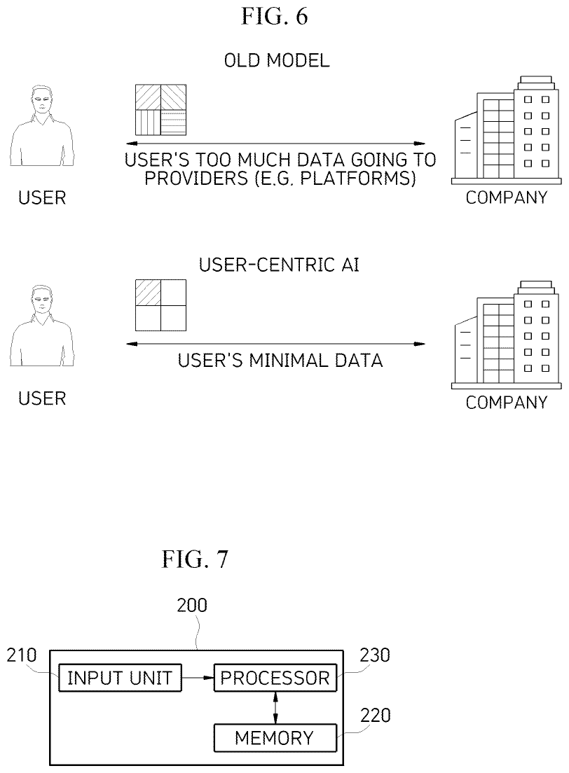

FIG. 6 is a view showing an artificial intelligence model according to the related art and an artificial intelligence model according to one embodiment of the present disclosure.

One embodiment of the present disclosure proposes a user-centric AI structure by expanding the payment model in the above-described user-centric AI service.

According to one embodiment of the present disclosure, the user's information is minimally accumulated by companies (only product purchase history information is accumulated to provide a product recommendation service without accumulating personal information, thereby eliminating the possibility of personal privacy infringement), and each company may provide a high-performance AI-based service without directly sharing its customer information with other companies.

That is, as shown in FIG. 6, the AI model structure according to the related art transfers all of the user's data to the company and the company provides a service by advancing the algorithm through the entire data, while the user-centric AI service model structure according to one embodiment of the present disclosure may provide an appropriate service (e.g., a product recommendation service) to the user using only the minimum amount of data.

That is, according to one embodiment of the present disclosure, the privacy of individual users can be preserved, data of business operators (corporate users) can be securely collaborated, and a relevant, novel, and beneficial service can be provided using minimal information.

Business operators (corporate users) may provide a service to individual users without directly sharing data between companies, and general users may receive relevant services while preserving their privacy when receiving the service.

FIG. 7 is a view showing the product recommendation service providing server 200 using purchase item information according to one embodiment of the present disclosure.

According to one embodiment of the present disclosure, for example, when customer A wants to make a purchase at a shopping mall, the shopping mall retrieves customers similar to customer A using only purchase information without using customer A's personal information (gender, age, occupation, and the like) in a process of recommending new items to customer A.

At this time, comprehensively considering products and number of times purchased by customer A, purchase dates and places, and the like, customer B with a similar purchase pattern is retrieved, and products that customer A has not purchased among products that customer B purchased are recommended to customer A.

According to one embodiment of the present disclosure, a recommendation service is provided using only purchase information without using the user's (general user's) personal information through the ECF.

According to one embodiment of the present disclosure, product recommendation information is provided using position information and time information in which a target customer is currently positioned.

For example, in the case of a coffee shop of Company A where the target customer is visiting for the first time, purchase information of other coffee shops (Company B, Company C, and the like) previously visited by the target customer and purchase information of other customers at the other coffee shops are used to consider purchase histories of the other customers similar to the target customer's tendency, thereby recommending products that are expected to give high satisfaction to the target customer among coffee shops of Company A.

In addition, in calculating similarity, it is possible to perform tendency identification only for the target customer in consideration of the purchase time information of the target customer.

For example, it is assumed that the target customer has a history of purchasing a cup of iced Americano at a coffee shop during the week while commuting to and from work, and a history of purchasing a cup of iced Americano and a cup of iced green tea latte at a coffee shop with his/her spouse on the weekend.

In that case, it is assumed that iced Americano is a beverage mainly consumed by the target customer, and iced green tea latte is a beverage mainly consumed by companions (e.g., spouse or friends) who are not the target customer.

Therefore, considering the time information (including date) that the target customer currently wants to order, in the case of the weekday, according to the above case, coffees (e.g., iced Americano) may be suggested as a recommended product at a coffee shop of Company A, and in the case of the weekend, recommended products (coffees or iced Americano) may be suggested for the target customer and recommended products (non-coffee type beverages, green tea latte, or sweet potato latte) may be suggested for companions at the coffee shop of Company A.

That is, although purchase information can be seen as including the tendency of the target customer, not all purchased items may be used by the target customer, and thus in a process of retrieving similar customers using purchase history and suggesting recommended products, it is possible to separately suggest recommended products not only for the target customer but also for companions accompanying the target customer comprehensively considering date, time, and location.

The product recommendation service providing server using purchase item information according to one embodiment of the present disclosure includes an input unit 210 for collecting user-specific purchase information, a memory 220 for storing a program that generates recommended product information for a target customer using the user-specific purchase information, and a processor 230 for executing the program. In this case, the processor 230 retrieves other customers of which purchase tendencies are within a preset similarity range with the target customer and generates recommended product information to be recommended to the target customer in consideration of items purchased by the other customers.

Here, the user-specific purchase information includes information about a purchased product, a purchaser, a purchase time, and a purchase location.

The processor 230 retrieves other customers with similar purchase tendency using the ECF algorithm for purchase information from a plurality of merchants.

The processor 230 builds a matrix for user-specific purchase information, retrieves other customers through cosine similarity based on the target customer, and recommends products purchased by the other customers.

The processor 230 detects similarity using vector-based ECF and generates recommended product information.

The processor 230 retrieves other customers with similar purchase tendency by training the user-specific purchase information as a sentence to obtain a product-to-vector that converts the purchase product history into a vector and generating a user purchase tendency vector by multiplying a product vector.

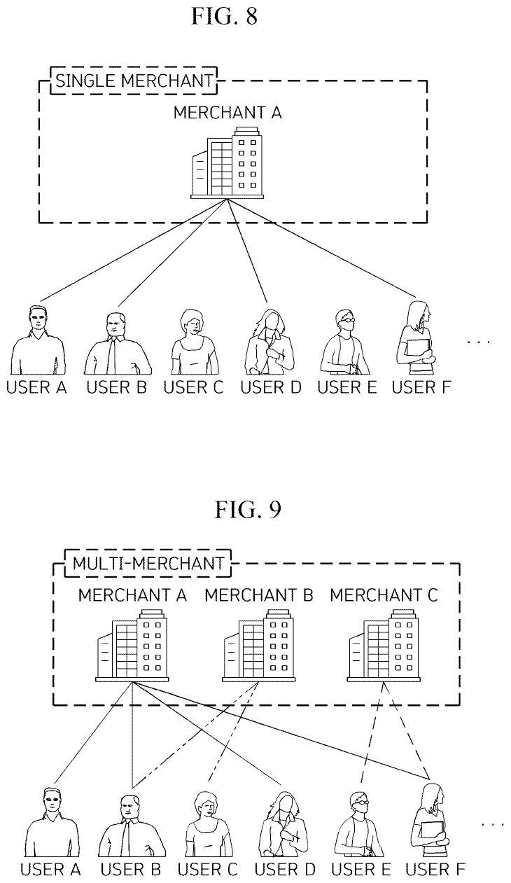

FIG. 8 is a view showing a single merchant and users according to the related art, and FIG. 9 is a view showing a multi-merchant and users according to one embodiment of the present disclosure.

Referring to FIG. 8, in the case of a single merchant, a recommendation service is provided using only the applicant's purchase information, and thus it is difficult to provide an appropriate recommendation service to a user who has visited the applicant for the first time, and to provide a recommendation service, it is necessary to retrieve similar users using the user's personal information and provide a recommendation service using the retrieved user's purchase history.

On the other hand, in the case of a multi-merchant of FIG. 9, even when the user visits the applicant for the first time, from the perspective of the target customer, it is possible to retrieve similar users in other stores without using personal information by reflecting the purchase information of other merchants and provide a recommendation service.

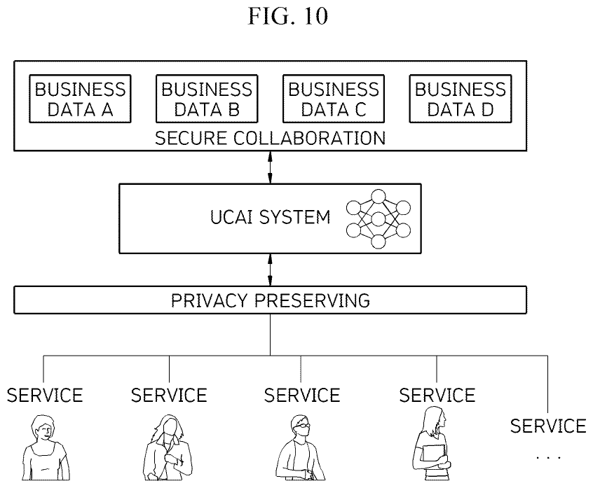

FIG. 10 is a view showing a user-centric artificial intelligence structure according to one embodiment of the present disclosure.

As described above, business data, that is, data of business operators (corporate users), can be securely collaborated, privacy can be preserved using only purchase information without using pieces of personal information of individual users, and the relevant, novel, and beneficial service can be provided.

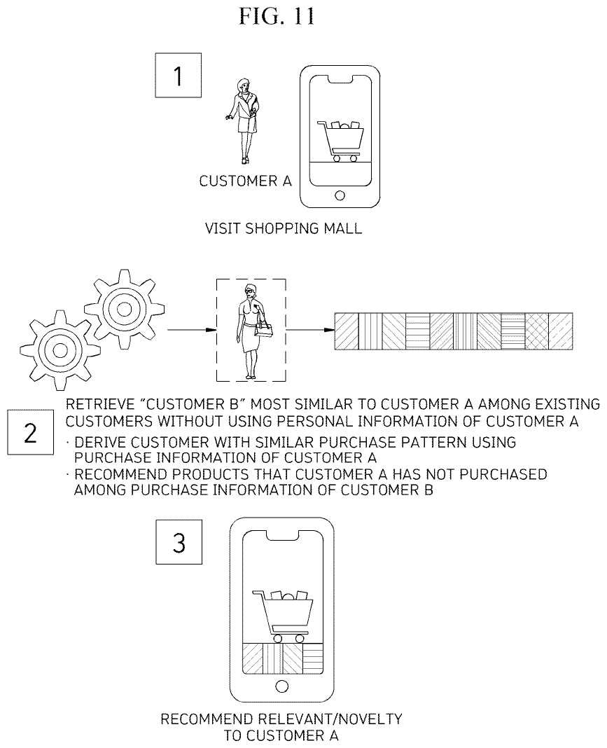

FIG. 11 is a view showing a product recommendation service scenario based on the user-centric artificial intelligence structure according to one embodiment of the present disclosure.

According to one embodiment of the present disclosure, for example, when customer A wants to make a purchase at a shopping mall, the shopping mall retrieves customers similar to customer A using only purchase information without using customer A's personal information (gender, age, occupation, and the like) in a process of recommending new items to customer A.

At this time, comprehensively considering products and number of times purchased by customer A, purchase dates and places, and the like, customer B with a similar purchase pattern is retrieved, and products that customer A has not purchased among products that customer B purchased are recommended to customer A.

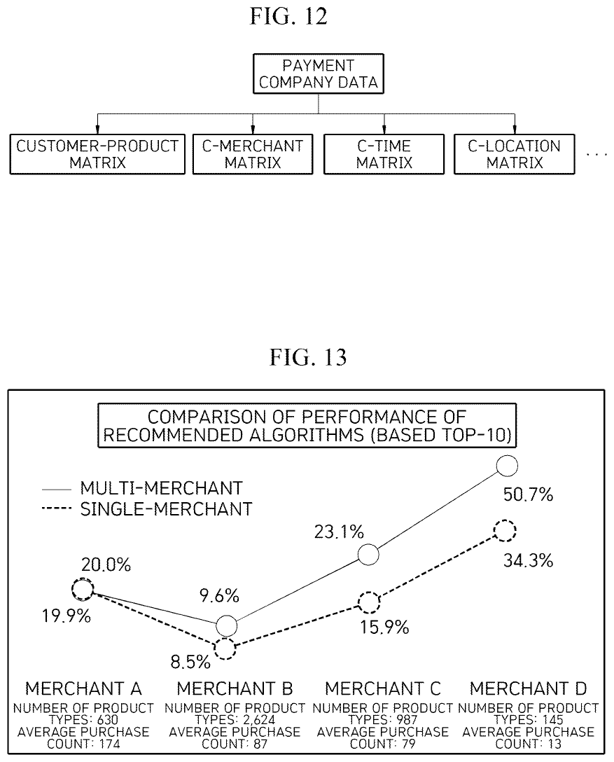

FIG. 12 is a view showing a recommendation service provision using payment data (purchase information) according to one embodiment of the present disclosure.

According to one embodiment of the present disclosure, to preserve the privacy of users (general users), personal information (gender, age, and the like) is not used, and only purchase information is used as minimum information.

The purchase information includes information about a purchased product, a purchaser, a purchase time, and a purchase location, and the purchase information is built in the form of a matrix to retrieve similar users, and a list of recommendations is generated using products purchased by similar users (at this time, the list of the recommendations may include top 5, top 10, and top 20 products).

According to one embodiment of the present disclosure, to supplement the insufficient data situation at a single merchant, a method of making recommendations using purchase information from other merchants is proposed, and to resolve the limitations of the single merchant, such as a new user problem (cold-star) and to analyze merchant preference patterns of users (general users) who use various merchant groups, purchase information is used through the ECF.

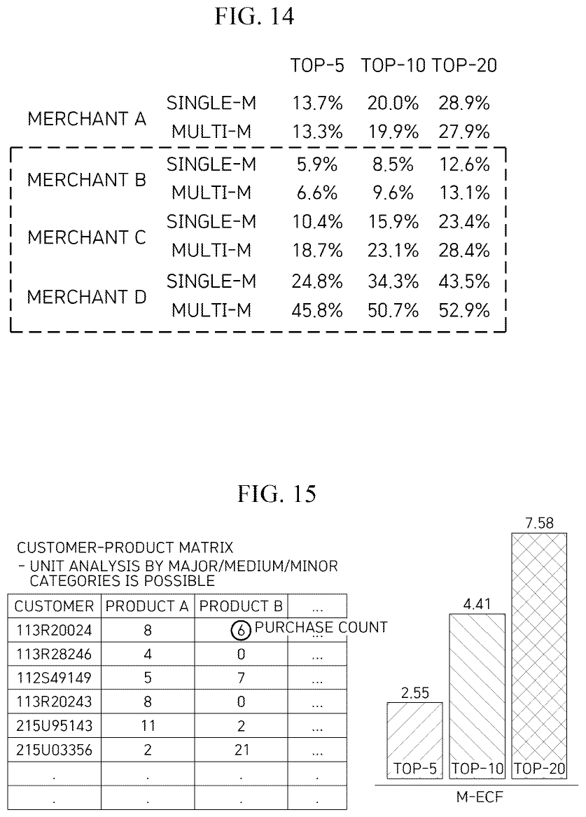

FIGS. 13 and 14 are views showing performance comparison results of recommendation algorithms according to one embodiment of the present disclosure, and FIG. 15 is a view showing performance results of a matrix-based ECF (M-ECF) according to one embodiment of the present disclosure.

From the perspective of a multi-merchant, payment data that may identify purchase information from various merchants was used as experimental data to verify the performance of the above-described ECF algorithm.

From the published raw data, users with various merchant purchase histories were extracted for developing algorithms, and a dataset was built using user-specific purchase information (purchased items, purchase merchants, and purchase time and location), which is essential information for purchase, exchange, and refund, and no other personal information was used.

To verify the performance of the ECF algorithm, it was assumed that there is a standardized category for products handled by each merchant, and recommendation performance was evaluated using the M-ECF (Matrix ECF) implemented based on the standardized code.

Referring to FIG. 15, a user purchase information dataset is built in the form of a matrix in which a standardized product category is one column, and then similar users are retrieved by deriving similarity with other users through cosine similarity based on the user, and products purchased by the similar users are recommended.

A method of evaluating the prediction accuracy of recommended products separates the last product from a list of products purchased by users into a label value in advance and evaluates prediction accuracy by comparing the last product with a finally recommended product, and a method of calculating prediction accuracy is as shown in [Equation 1].

$$Acc = \frac{the number of matched users}{the number of recommended users} \times 100 \qquad [ Equation 1 ]$$

The ECF algorithm developed through public payment data was applied to actual payment history data to empirically verify whether the ECF algorithm had relevant recommendation results.

FIGS. 13 and 14 show the result of comparing and evaluating a matrix-based ECF algorithm from the perspective of a single merchant and a multi-merchant, and from the perspective of the single merchant, recommendation was made using only the user purchase information of the applicant for each of Merchants A, B, C, and D, and from the perspective of the multi-merchant, recommendation was made to Merchants A, B, C, and D through pieces of purchase information of all users.

As a result, it can be confirmed that there is no significant difference between Merchant A and B with many types of products and a larger amount of pieces of purchase information, while the ECF algorithm shows higher prediction accuracy than the single merchant for Merchant C and D with a smaller amount of pieces of purchase information.

That is, large companies with a large number of pieces of purchase information show sufficient recommendation performance using only the applicant's data, but small and medium-sized companies lack data to make recommendations, and thus as a result of using pieces of purchase information of other merchants, it was confirmed that the ECF algorithm was effective.

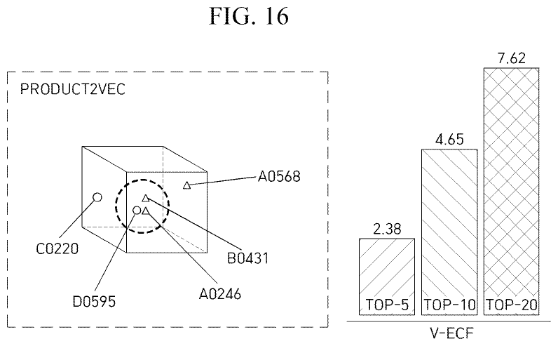

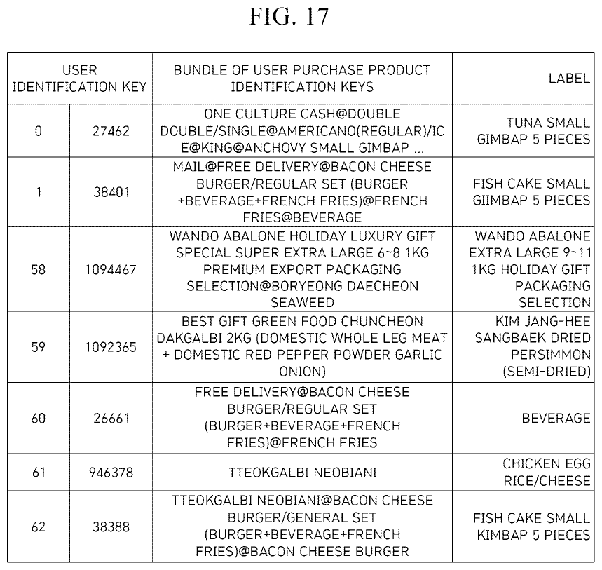

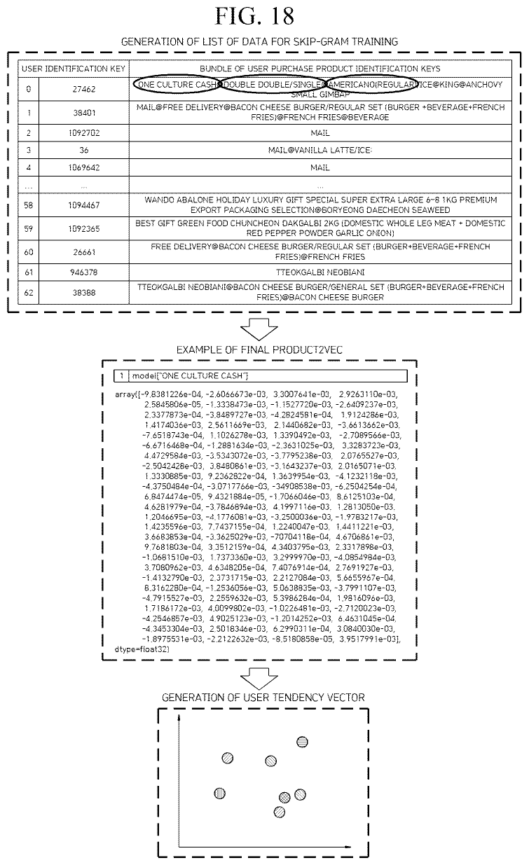

FIG. 16 is a view showing performance results of a V-ECF according to one embodiment of the present disclosure, FIG. 17 is a view showing preprocessing completion data according to one embodiment of the present disclosure, and FIG. 18 is a view showing product-to-vector (Product2vec) and user propensity vector generation according to one embodiment of the present disclosure.

Referring to FIG. 17, excluding empty (NULL) values in the product name (considering all of Product name 1, Product name 2, and Product name 3), products purchased only once are excluded because model training is not performed properly.

To check the result of the recommendation, the last product is a label value for performance evaluation, and thus the minimum number of purchases needs to be 2 or more.

A list of products (a bundle of user-purchased product identification keys) is generated for each user.

Referring to FIG. 16, the V-ECF is used so that natural language may be used for processing.

According to one embodiment of the present disclosure, a word-to-vector (Word2vec) model is used to set products purchased by a user to words and train the list of purchased products as sentences through a Skip-gram technique.

That is, the actual purchase product history is converted into vectors, which is defined as purchased product to vector (Product2Vec).

The product to vector generated in this way is multiplied by each product vector purchased by the user to generate a user purchase tendency vector, and similar users are retrieved through similarity calculation.

According to one embodiment of the present disclosure, by using a recommendation algorithm in natural language without categorizing the user's product purchase information, it is possible to directly reflect newly appearing products in the recommendation algorithm without a separate classification process.

In addition, from the perspective of the multi-merchant, the process of categorizing product names that do not match each merchant is unnecessary, and furthermore, it is possible to automatically reflect products of global merchants used in different languages in the recommendation algorithm.

Hereinafter, the result of comparing the matrix-based ECF and the vector-based ECF in [Table 1] shows similar recommendation prediction accuracy.

TABLE 1

| Items | M-ECF | V-ECF |
|---|---|---|
| Top-5 | 2.55% | 2.38% |
| Top-10 | 4.41% | 4.65% |
| Top-20 | 7.58% | 7.62% |

Since the vector-based ECF processes product purchase information in natural language without processing, it is possible to reflect the product purchase information in the recommendation algorithm without human determination and intervention.

In addition, as described above, in the case of the multi-merchant in which various products are newly introduced, product names between other merchants do not match, and it can be confirmed that the performance of the vector-based ECF is secured compared to the matrix-based ECF that requires separate processing for product information.

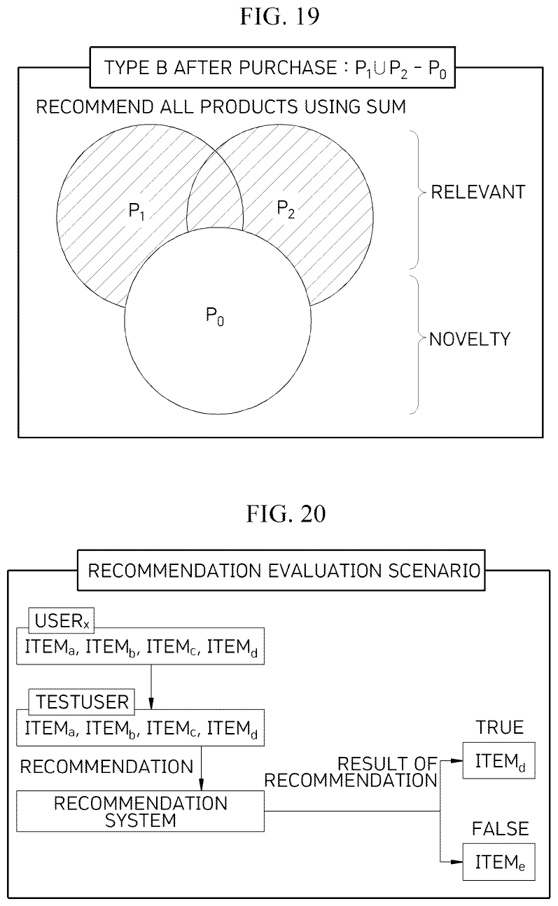

FIG. 19 is a view showing product recommendation results according to one embodiment of the present disclosure.

When P₁ is defined as a product purchased by a similar user, P₂ is defined as a product with high similarity to a product just purchased by a target customer (the above-described customer A), and P₀ is defined as a product purchased by the target customer (the above-described customer A) in the past, the result of subtracting P₀ from the sum of P₁ and P₂ is recommended.

FIG. 20 is a view showing a recommendation evaluation scenario according to one embodiment of the present disclosure.

The number of purchases varies by user, and the last product purchased by the actual user is removed to create a test user, and the user most similar to a new user (target user) is retrieved through similarity calculation.

Excluding common purchase products of users similar to the target user, items most frequently purchased by similar users are recommended as top 5, 10, and 20, and when the target user purchases one of the recommended products, it is considered a relevant recommendation.

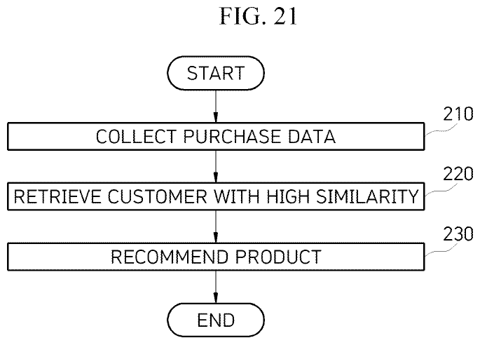

FIG. 21 is a view showing a product recommendation service providing method using purchase item information according to one embodiment of the present disclosure.

A method performed by a product recommendation service providing server using purchase item information according to one embodiment of the present disclosure includes an operation S210 of collecting purchase information according to completed purchases from a plurality of merchants, an operation S220 of retrieving other customers with high similarity in purchase tendency to a target customer using the purchase information, and an operation S230 of recommending products to the target customer using pieces of purchase item information of other customers.

The operation S210 includes collecting purchase information including information about a purchased product, a purchaser, a purchase time, and a purchase location.

The operation S220 includes retrieving other customers using an extrapolation collaborative filtering algorithm.

The operation S220 includes building a matrix for purchase information for each user and retrieving other customers with high similarity in purchase tendency based on the target customer.

The operation S220 includes retrieving other customers using a vector-based extrapolation collaborative filtering algorithm.

The operation S220 includes retrieving other customers by training purchase information as sentences, obtaining a product-to-vector that converts a purchase product history into a vector, and multiplying the product vector to generate a user purchase tendency vector.

According to the product recommendation service providing server 200 and method according to one embodiment of the present disclosure, it is possible to provide a relevant product recommendation service to the target customer by retrieving customers similar to the target customer among existing customers without using the customer's personal information.

In addition, by collecting only the minimum information about the customer and providing the service, it is possible to preserve the privacy of individual users and provide a relevant, novel, and beneficial service while securely and fairly collaborating between business operators without mutually sharing or integrating the data of users (corporate users).

The above-described one embodiment of the present disclosure may be implemented in the form of a program (or application) to be executed in combination with a computer as hardware and may be stored in a medium.

The above-described program may include codes coded in a computer language, such as C, C++, JAVA, Ruby, or machine language, which can be read by a processor (CPU) of the computer through a device interface of the computer so that the computer reads the program and executes the methods implemented by the program. These codes may include functional codes related to functions that define functions necessary for executing the above-described methods and include control codes related to execution procedures necessary for the processor of the computer to execute the above-described functions according to a predetermined procedure. In addition, these codes may further include memory reference-related codes regarding which location (address) of an internal or external memory of the computer should be referenced for additional information or media necessary for the processor of the computer to execute the above-described functions. In addition, when the processor of the computer needs to communicate with any other computer or server positioned remotely in order to execute the functions, the code may further include communication-related codes regarding how to communicate with any other computer or server positioned remotely using the communication module of the computer, what information or media to send and receive during communication, and the like.

The storage medium is a medium that semi-permanently stores data and may be read by a device rather than a medium that stores data for a short time, such as a register, a cache, or a memory. Specifically, examples of the storage medium include a read-only-memory (ROM), a random access memory (RAM), a CD-ROM, a magnetic tape, a floppy disk, or an optical data storage device, but are not limited thereto. That is, the program may be stored in any storage media on any server that the computer can access or in any storage media on the user's computer. In addition, since the medium may be distributed to a computer system connected to a network, a code that can be read by the computer may be stored in a distributed manner.

The above description of the present disclosure is for illustrative purpose, and those skilled in the art to which the present disclosure pertains will be able to understand that the present disclosure may be easily modified in other specific forms without changing the technical spirit or essential features thereof. Therefore, it should be understood that the above-described embodiments are illustrative and not restrictive in all respects. For example, each component described in a singular form may be implemented separately, and likewise, components described as being implemented separately may also be implemented in a combined form.

The scope of the present disclosure is defined by the appended claims rather than the detailed description, and all changes or modifications derived from the meaning and scope of the claims and equivalent concepts thereof should be construed as being included in the scope of the present disclosure.

1. A user-centric hyper-personalized product recommendation and target marketing system comprising:
an input unit configured to collect user-specific purchase information;
a memory configured to store a program for generating recommended product information and target marketing information for a target customer based on the user-specific purchase information; and
a processor configured to execute the program stored in the memory,
wherein the processor generates a list of user-specific recommended products based on the recommended product information for the target customer and generates target marketing information by cross-checking the list of the user-specific recommended products on a product basis.

2. The user-centric hyper-personalized product recommendation and target marketing system of claim 1, wherein the processor cross-checks first recommended product information corresponding to a first user included in the list of the user-specific recommended products and generates target marketing information including a plurality of second users including the first user based on the first recommended product information.

3. The user-centric hyper-personalized product recommendation and target marketing system of claim 2, wherein the processor generates the target marketing information by arranging a first merchant selling products of the first recommended product information based on the purchase information and a second merchant different from the first merchant selling products of the first recommended product information.

4. The user-centric hyper-personalized product recommendation and target marketing system of claim 1, wherein the processor retrieves other customers of which purchase tendencies are within a preset similarity range with the target customer and generates recommended product information to be recommended to the target customer in consideration of items purchased by the other customers.

5. The user-centric hyper-personalized product recommendation and target marketing system of claim 4, wherein the processor retrieves other customers with preset similarity with the purchase tendency using an extrapolative collaborative filtering algorithm for pieces of the purchase information at a plurality of merchants.

6. The user-centric hyper-personalized product recommendation and target marketing system of claim 5, wherein the processor builds a matrix for the user-specific purchase information, retrieves the other customers through cosine similarity based on the target customer, and generates the recommended product information that recommends products purchased by the other customers.

7. The user-centric hyper-personalized product recommendation and target marketing system of claim 5, wherein the processor detects similarity using vector-based extrapolative collaborative filtering and generates the recommended product information.

8. The user-centric hyper-personalized product recommendation and target marketing system of claim 5, wherein the processor retrieves other customers with similar purchase tendency by training the user-specific purchase information as a sentence to obtain a product-to-vector that converts a purchase product history into a vector and generating a user purchase tendency vector by multiplying a product vector.

9. A method performed by a user-centric hyper-personalized product recommendation and target marketing system, the method comprising:
collecting pieces of purchase information according to completed purchase at a plurality of merchants;
generating a list of user-specific recommended products based on recommended product information for a target customer using the purchase information; and
generating target marketing information by cross-checking the list of the user-specific recommended products on a product basis.

10. The method of claim 9, wherein the generating of the target marketing information by cross-checking the list of the user-specific recommended products on a product basis includes:
cross-checking first recommended product information corresponding to a first user included in the list of user-specific recommended products; and
generating target marketing information including a plurality of second users including the first user based on the first recommended product information.

11. The method of claim 10, wherein the generating of the target marketing information by cross-checking the list of the user-specific recommended products on a product basis includes generating the target marketing information by arranging a first merchant selling products of the first recommended product information based on the purchase information and a second merchant different from the first merchant selling products of the first recommended product information.
